(19) United States
(12) Patent Application Publication
(10) Pub. No.: US 2014/0337349 A1
(43) Pub. Date: Nov. 13, 2014

(54) ELECTRONIC DEVICE AND DOCUMENT CLASSIFICATION METHOD

(71) Applicant: Hon Hai Precision Industry Co., Ltd., New Taipei (TW)

(72) Inventors: CHUNG-I LEE, New Taipei (TW); YUE-CEN LIU, New Taipei (TW); GEN-CHI LU, New Taipei (TW)

(73) Assignee: HON HAI PRECISION INDUSTRY CO., LTD., New Taipei (TW)

(21) Appl. No.: 14/273,488

(22) Filed: May 8, 2014

(30) Foreign Application Priority Data
May 9, 2013 (CN) 201310169201X

(51) Int. Cl. G06F 17/30

(52) U.S. Cl. CPC G06F 17/30598; G06F 17/30011
USPC 707/740

(57) ABSTRACT

In a document classification method being executed by a processor of an electronic device, documents to be classified and categorical descriptions of the documents are received. Each document is classified into one or more categories according to a similarity between the document and each category specified in the categorical descriptions. The one or more categories into which each document is classified are outputted to an output device.

### BACKGROUND

1. Technical Field

The embodiments of the present disclosure relate to classification systems and methods, and particularly to an electronic device and a document classification method of the electronic device.

2. Description of Related Art

Documents can be classified into different categories according to a certain attribute of subject matters of the documents. For example, LCD patent documents can be classified into a wide view category and a transflective/reflective category according to technical field of the subject matters of the documents. However, it would be desirable to classify the documents into different categories according to different attributes of the subject matters in some cases.

### BRIEF DESCRIPTION OF THE DRAWINGS

FIG. 1 shows one embodiment of an electronic device.

FIG. 2 is a block diagram of one embodiment of function modules of a document classification system of the electronic device in FIG. 1.

FIG. 3 is a flowchart of one embodiment of a document classification method of the electronic device in FIG. 1.

FIG. 4 is a detailed flowchart illustrating block 35 in FIG. 3.

FIG. 5 is one embodiment illustrating attributes and categories of subject matters specified in categorical descriptions of LCD patent documents.

FIG. 6 shows one embodiment of a classification of LCD patent documents.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

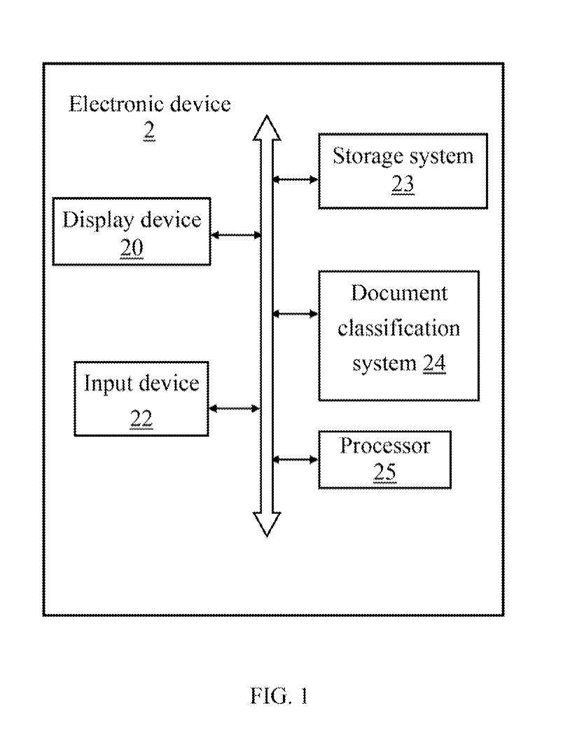

FIG. 1 shows one embodiment of an electronic device 2. The electronic device 2 includes a display device 20, an input device 22, and a document classification system 24. The electronic device 2 may be a computer, a mobile phone, or a personal digital assistant. The document classification system 24 classifies documents into different categories according to different attributes of subject matters of the documents. The display device 20 displays classifications of the documents obtained by the document classification system 24. The input device 22 may be a keyboard or an electronic mouse, which receives user input. FIG. 1 is one example of the electronic device 2, other examples may comprise more or fewer components than those shown in the embodiment, or have a different configuration of the various components.

The electronic device 2 may further include a storage system 23 and at least one processor 25. The storage system 23 can be a dedicated memory, such as EPROM, a hard disk drive (HDD), or a flash memory. In some embodiments, the storage system 23 can also be an external storage device, such as an external hard disk, a storage card, or other data storage medium. The at least one processor 25 can be a central processing unit (CPU), a microprocessor, or other suitable data processor chip that performs various functions of the electronic device 2.

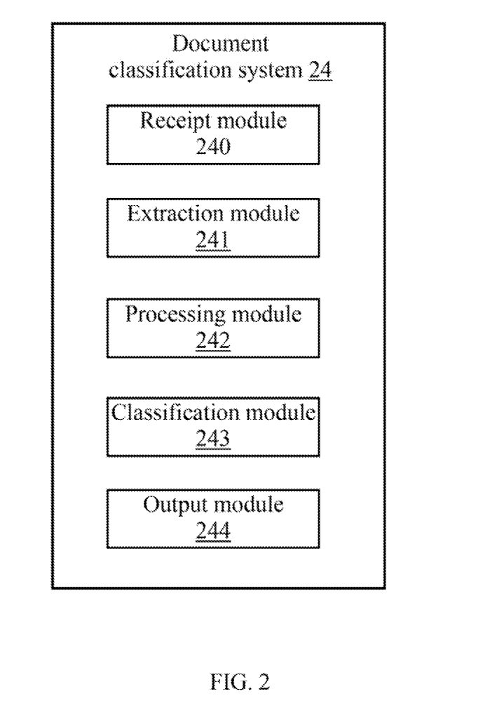

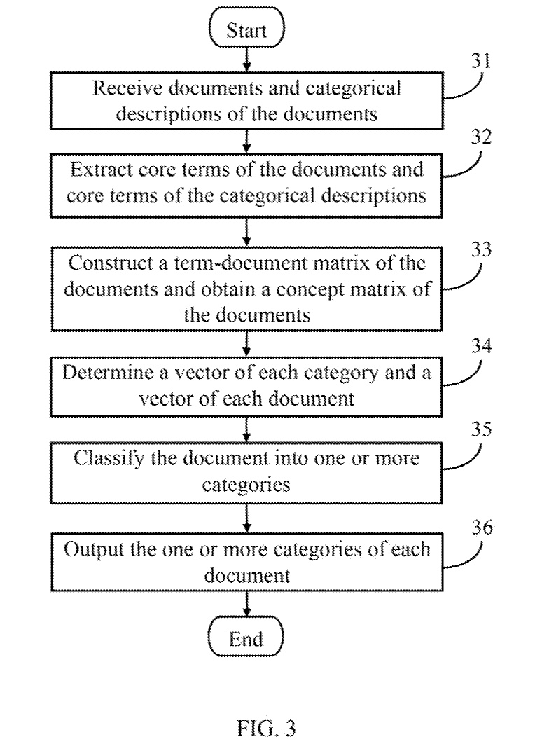

FIG. 2 is a block diagram of one embodiment of function modules of the document classification system 24 shown in FIG. 1. The document classification system 24 includes a receipt module 240, an extraction module 241, a processing module 242, a classification module 243, and an output module 244. The modules 240-244 may comprise computerized codes in the form of one or more computer-readable programs that are stored in a non-transitory computer-readable medium, such as the storage system 23. The computerized codes include instructions that are executed by the at least one processor 25, to provide the aforementioned functions of the document classification system 24. A detailed description of the functions of the modules 240-244 is given below in reference to FIG. 3.

FIG. 3 is a flowchart of one embodiment of a document classification method of the electronic device 2 in FIG. 1. Depending on the embodiment, additional blocks may be added, others removed, and the ordering of the blocks may be changed.

At block 31, the receipt module 240 receives a plurality of documents to be classified and receives categorical descriptions of the documents. The documents may be obtained from the storage system 23 according to keywords input by the user. For example, the user inputs keywords “liquid crystal display (LCD)” and “patent” and obtains a plurality of LCD patent documents. The categorical descriptions specify one or more attributes of the subject matters of the documents, according to which the documents may be classified. The categorical descriptions further specify various categories corresponding to each attribute. Each category may include several sub-categories.

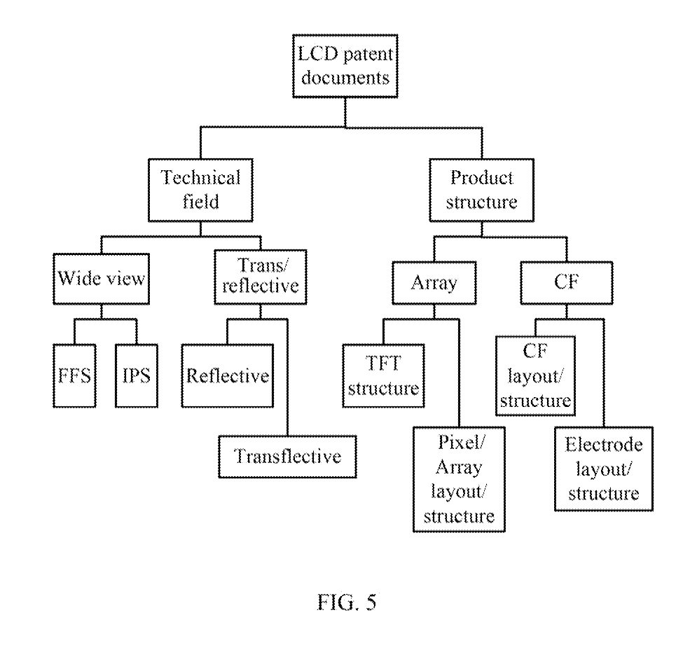

FIG. 5 is one embodiment illustrating attributes and categories of subject matters specified in categorical descriptions of LCD patent documents. The attributes of the subject matters of the LCD patent documents include technical field and product structure. According to technical field, the LCD patent documents can be classified into a wide view category and a transflective/reflective (trans/reflective) category. The wide view category includes a fringe field switching (FFS) sub-category and an in-plane-switching (IPS) sub-category. The trans/reflective category includes a reflective sub-category and a transflective sub-category. According to product structure, the LCD patent documents can be classified into an array category and a color filter (CF) category. The array category includes a thin film transistor (TFT) structure sub-category and a pixel/array layout/structure sub-category. The CF category includes a CF layout/structure sub-category and an electrode layout/structure sub-category.

At block 32, the extraction module 241 extracts core terms of the documents and core terms of the categorical descriptions. The extraction module 241 may divide each document into different blocks and extract the core terms of the documents from the blocks. For example, for a patent document, each of the parts (for example, title, abstract, detailed description, and claims) of the patent document is regarded as a single block. The core terms may be extracted using a natural language processing method, such as a term frequency-inverse document frequency method. In one embodiment, the extraction module 241 may set a weight for each core term of a document. The weight may be adjusted according to a position of the core term in the document. For example, for a patent document, if a core term is extracted from abstract, a weight for the core term is adjusted to a larger value.

At block 33, the processing module 242 constructs a term-document matrix of the documents according to the core terms of the documents, and performs a dimension reduction operation on the term-document matrix to obtain a concept matrix of the documents in a concept space.

At block 34, the processing module 242 determines a vector of each category specified in the categorical descriptions in the concept space according to the core terms of the categorical descriptions, and determines a vector of each document in the concept space from the concept matrix. The vector of each category and the vector of each document may be concept vectors. In one embodiment, the processing module 242 determines an overall vector of all categories specified in the categorical descriptions in the concept space according to all the core terms of the categorical descriptions. The processing module 242 parses the overall vector to obtain a vector corresponding to each attribute specified in the categorical descriptions, and parses the vector corresponding to each attribute to obtain the vector of each category.

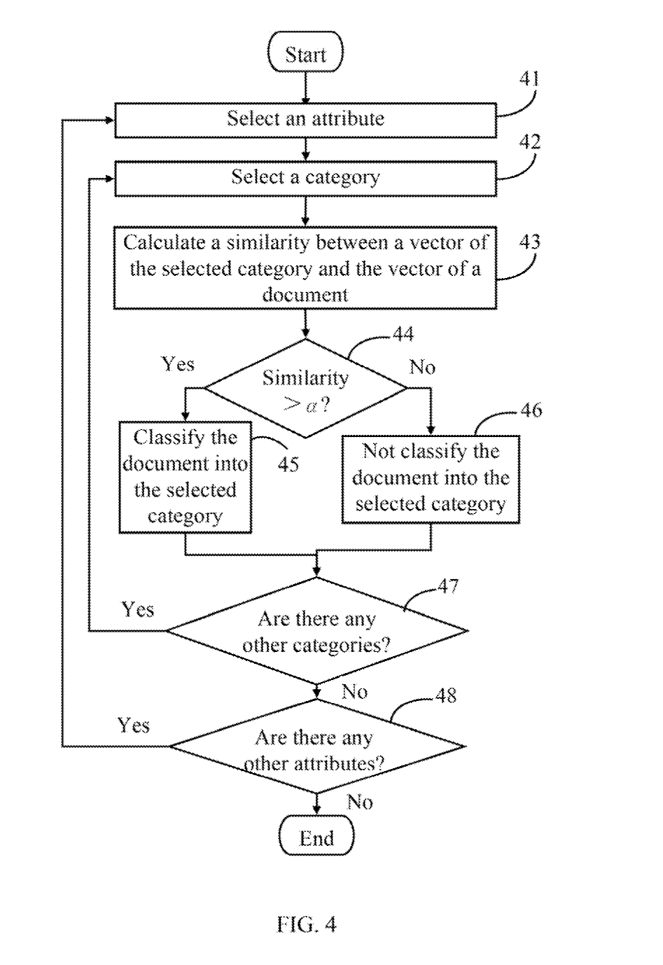

At block 35, for each document, the classification module 243 classifies the document into one or more categories according to a similarity between the vector of each category specified in the categorical descriptions and the vector of the document. Further details of block 35 are described below in reference to FIG. 4.

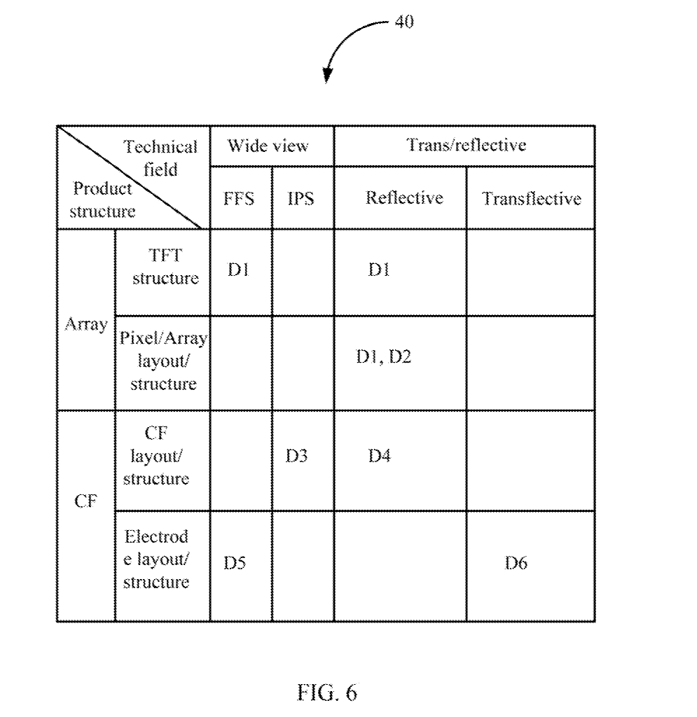

At block 36, the output module 244 outputs the one or more categories of each document on the display device 20 when all the documents have been classified. FIG. 6 shows one embodiment of a classification of LCD patent documents D1-D6. In this embodiment, the classification is outputted in a form of a document classification table 40.

FIG. 4 is a detailed flowchart illustrating one embodiment of classifying a document into one or more categories according to the vector of each category specified in categorical descriptions and the vector of the document (block 35 in FIG. 3).

At block 41, the classification module 243 selects an attribute specified in the categorical descriptions. In one example with respect to FIG. 5, the classification module 243 selects the attribute of technical field.

At block 42, the classification module 243 selects a category corresponding to the selected attribute specified in the categorical descriptions. In one example, the classification module 243 selects the wide view category corresponding to the selected attribute of technical field. In another example, the classification module 243 selects the FFS sub category corresponding to the selected attribute of technical field.

At block 43, the classification module 243 calculates a similarity between the vector of the selected category and the vector of the document. In one embodiment, the similarity is a cosine value of an angle between the vector of the selected category and the vector of the document. The less the divergence, or the smaller the angle between the two vectors, then the larger will be the cosine value of the angle, and the greater will be the similarity between the two vectors.

At block 44, the classification module 243 determines whether the similarity between the vector of the selected category and the vector of the document is greater than a preset value α, for example, α=0.8.

If the similarity is greater than the preset value, At block 45, the classification module 243 classifies the document into the selected category.

If the similarity is less than or equal to the preset value, At block 46, the classification module 243 does not classify the document into the selected category.

At block 47, the classification module 243 determines whether there are any other categories corresponding to the selected attribute which have not been selected. If there are corresponding but unselected other categories, the flow returns to block 42.

If there are no other corresponding but unselected categories, At block 48, the classification module 243 determines whether there are any other attributes that have not been selected. If there are other unselected attributes, the flow returns to block 41. If all attributes have been selected, the flow ends.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A document classification method being executed by a processor of an electronic device, the method comprising:
(a) receiving a plurality of documents and categorical descriptions of the documents, the categorical descriptions specifying one or more attributes of subject matters of the documents and one or more categories corresponding to each attribute;
(b) classifying each document into one or more categories according to a similarity between the document and each category specified in the categorical descriptions; and
(c) outputting the one or more categories of each document to an output device.

2. The method of claim 1, wherein (b) comprises:
(b1) extracting core terms of the documents and core terms of the categorical descriptions;
(b2) constructing a term-document matrix of the documents according to the core terms of the documents, and obtaining a concept matrix of the documents in a concept space according to the term-document matrix;
(c) determining a vector of each category specified in the categorical descriptions in the concept space according to the core terms of the categorical descriptions, and determining a vector of each document in the concept space from the concept matrix; and
(c) classifying each document into one or more categories according to a similarity between the vector of each category specified in the categorical descriptions and the vector of the document.

3. The method of claim 2, wherein the document is classified into a category upon condition that the similarity between the vector of the category and the vector of the document is greater than a preset value.

4. The method of claim 2, wherein the similarity is a cosine value of an angle between the vector of the category and the vector of the document.

5. The method of claim 1, wherein the one or more categories of each document are outputted in a form of a document classification table.

6. An electronic device, comprising:
at least one processor; and
a storage system storing a computer-readable program comprising a plurality of instructions, which when executed by the at least one processor, causes the at least one processor to perform operations comprising:
(a) receiving a plurality of documents and categorical descriptions of the documents, the categorical descriptions specifying one or more attributes of subject matters of the documents and one or more categories corresponding to each attribute;
(b) classifying each document into one or more categories according to a similarity between the document and each category specified in the categorical descriptions; and
(c) outputting the one or more categories of each document to an output device.

7. The electronic device of claim 6, wherein operation (b) comprises:
(b1) extracting core terms of the documents and core terms of the categorical descriptions;
(b2) constructing a term-document matrix of the documents according to the core terms of the documents, and obtaining a concept matrix of the documents in a concept space according to the term-document matrix;
(c) determining a vector of each category specified in the categorical descriptions in the concept space according to the core terms of the categorical descriptions, and determining a vector of each document in the concept space from the concept matrix; and
(c) classifying each document into one or more categories according to a similarity between the vector of each category specified in the categorical descriptions and the vector of the document.

8. The electronic device of claim 7, wherein the document is classified into a category upon condition that the similarity between the vector of the category and the vector of the document is greater than a preset value.

9. The electronic device of claim 7, wherein the similarity is a cosine value of an angle between the vector of the category and the vector of the document.

10. The electronic device of claim 6, wherein the one or more categories of each document are outputted in a form of a document classification table.

11. A non-transitory computer-readable storage medium storing a set of instructions, the set of instructions capable of being executed by a processor of an electronic device to implement a document classification method, the method comprising:
(a) receiving a plurality of documents and categorical descriptions of the documents, the categorical descriptions specifying one or more attributes of subject matters of the documents and one or more categories corresponding to each attribute;
(b) classifying each document into one or more categories according to a similarity between the document and each category specified in the categorical descriptions; and
(c) outputting the one or more categories of each document to an output device.

12. The storage medium of claim 11, wherein (b) comprises:
(b1) extracting core terms of the documents and core terms of the categorical descriptions;
(b2) constructing a term-document matrix of the documents according to the core terms of the documents, and obtaining a concept matrix of the documents in a concept space according to the term-document matrix;
(c) determining a vector of each category specified in the categorical descriptions in the concept space according to the core terms of the categorical descriptions, and determining a vector of each document in the concept space from the concept matrix; and
(c) classifying each document into one or more categories according to a similarity between the vector of each category specified in the categorical descriptions and the vector of the document.

13. The storage medium of claim 12, wherein the document is classified into a category upon condition that the similarity between the vector of the category and the vector of the document is greater than a preset value.

14. The storage medium of claim 12, wherein the similarity is a cosine value of an angle between the vector of the category and the vector of the document.

15. The storage medium of claim 11, wherein the one or more categories of each document are outputted in a form of a document classification table.
